(19) United States
(12) Patent Application Publication
(10) Pub. No.: US 2024/0318075 A1
(43) Pub. Date: Sep. 26, 2024

(54) A RADIATION SENSING MATERIAL

(71) Applicant: Turun yliopisto, Turun yliopisto (FI)

(72) Inventors: Mika Lastusaari, Turku (FI); Isabella Pönkkä, Turku (FI); Hannah Byron, Turku (FI); Teppo Kreivilä, Turku (FI)

(21) Appl. No.: 18/572,828

(22) PCT Filed: Jun. 17, 2022
(86) PCT No.: PCT/FI2022/050422

§ 371 Date: Dec. 21, 2023

(30) Foreign Application Priority Data
Jun. 23, 2021 (FI) 20215742

(51) Int. Cl. C09K 11/64; C01B 33/26; C09K 9/00; C09K 11/88; G01J 1/50; G01T 1/04; G01T 1/10

(52) U.S. Cl. CPC C09K 11/646; C01B 33/26; C09K 9/00; C09K 11/881; C01P 2002/52; C01P 2002/72; C01P 2006/60; G01J 1/50; G01T 1/04; G01T 1/10

(57) ABSTRACT

A radiation sensing material is disclosed. The radiation sensing material is represented by the following formula (I):

(M1′₈₋₂ₐM2′ₐ)(M″_{14-(4b/3)}M′″_{b})O₂₄(X_{2-dc}dX′ₙ^{c-}):M″″ formula (I)

Further is disclosed a device and uses of the radiation sensing material represented by the formula (I).

### TECHNICAL FIELD

The present disclosure relates to a radiation sensing material. The present disclosure further relates to a device, a material, and to the uses of the radiation sensing material.

### BACKGROUND

Photochromism is considered as the reversible transformation of a chemical species between two forms by the absorption of electromagnetic radiation, where the two forms have different absorption spectra. I.e. photochromism can be described as a reversible change of color upon exposure to radiation. Photochromism is usually used to describe compounds that undergo a reversible photochemical reaction where an absorption band in the visible part of the electromagnetic spectrum changes dramatically in strength or wavelength. Reversible photochromic material can be found in applications such as toys, cosmetics, clothing and industrial applications. In addition to this or alternatively for a material to being photochromic, it may be a luminescent material. “Luminescence” refers to the property of the material to being able to emit light without being heated. A luminescent material may be used e.g. in illumination applications.

### SUMMARY

A radiation sensing material is disclosed. The radiation sensing material is represented by the following formula (I):

(M1′₈₋₂ₐM2′ₐ)(M″_{14-(4b/3)}M′″_{b})O₂₄(X_{2-dc}dX′ₙ^{c-}):M″″ formula (I)

wherein
M1′ represents a monovalent monoatomic cation of an alkali metal selected from Group 1 of the IUPAC periodic table of the elements, or any combination of such cations;
M2′ represents a divalent monoatomic cation of an alkaline earth metal selected from Group 2 of the IUPAC periodic table of the elements, or any combination of such cations;
M″ represents a trivalent monoatomic cation of an element selected from Group 13 of the IUPAC periodic table of the elements, or any combination of such cations;
M′″ represents a monoatomic cation of an element selected from Group 14 of the IUPAC periodic table of the elements, or any combination of such cations;
X represents an anion of an element selected from the halogens of Group 17 of the IUPAC periodic table of the elements, or any combination of such anions;
X′ represents an anion of one or more elements selected from the chalcogens of Group 16 of the IUPAC periodic table of the elements, or any combination of such anions;
M″″ represents a dopant cation of an element selected from rare earth metals of the IUPAC periodic table of the elements, or from transition metals of the IUPAC periodic table of the elements, or of Ba, Sr, TI, Pb, or Bi, or any combination of such cations, or wherein M″″ is absent; and
a is a value of 0.05-4;
b is a value of 1-10;
c is a value of 1, 2, 3, or 4;
d is a value of above 0-2;
n is a value of 1, 2, 3, or 4.

Further is disclosed a device comprising the radiation sensing material as disclosed in the current specification.

Further is disclosed a material derived from the radiation sensing material as disclosed in the current specification.

Further is disclosed the use of the radiation sensing material as disclosed in the current specification for indicating the presence and/or intensity of ultraviolet radiation, x-radiation, gamma-radiation, infrared radiation, near-infrared radiation, and/or particle radiation.

Further is disclosed the use of the radiation sensing material as disclosed in the current specification as a light source, in a consumer product, in a security device, in detecting, in imaging, in image acquisition, in display, screen, window, or touch screen solution, in medicine, in drug development, and/or in diagnostics.

Further is disclosed the use of the radiation sensing material as disclosed in the current specification for detection of a disease, in an antibody or staining entity, in a biomarker test kit, in a screening platform, and/or in a combination with a further material.

### BRIEF DESCRIPTION OF THE DRAWINGS

The accompanying drawings, which are included to provide a further understanding of the embodiments and constitute a part of this specification, illustrate embodiments and together with the description help to explain the principles of the above. In the drawings:

FIGS. 1a and 1b show the results from the X-ray powder diffraction (XRD) measurements;

FIGS. 2a, 2b, and 2c, show the results from reflectance measurements;

FIGS. 3a, 3b, and 3c show the results from the tenebrescence color rise measurements

FIGS. 4a and 4b show the results from the photoluminescence measurements;

FIGS. 5a and 5b show the results from the persistent luminescence measurements;

FIG. 6 show the results from the thermoluminescence measurements;

FIG. 7 show a photograph of the yellow photochromism;

FIG. 8 show a photograph of the near-infrared photochromism; and

FIG. 9a, FIG. 9b, and FIG. 10 show the results from the double-excitation emission simulation test.

### DETAILED DESCRIPTION

The present disclosure relates to a radiation sensing material. The radiation sensing material is represented by the following formula (I):

(M1′₈₋₂ₐM2′ₐ)(M″_{14-(4b/3)}M′″_{b})O₂₄(X_{2-dc}dX′ₙ^{c-}):M″″ formula (I),

wherein
M1′ represents a monovalent monoatomic cation of an alkali metal selected from Group 1 of the IUPAC periodic table of the elements, or any combination of such cations;
M2′ represents a divalent monoatomic cation of an alkaline earth metal selected from Group 2 of the IUPAC periodic table of the elements, or any combination of such cations;
M″ represents a trivalent monoatomic cation of an element selected from Group 13 of the IUPAC periodic table of the elements, or any combination of such cations;
M′″ represents a monoatomic cation of an element selected from Group 14 of the IUPAC periodic table of the elements, or any combination of such cations;
X represents an anion of an element selected from the halogens of Group 17 of the IUPAC periodic table of the elements, or any combination of such anions;
X′ represents an anion of one or more elements selected from the chalcogens of Group 16 of the IUPAC periodic table of the elements, or any combination of such anions;
M″″ represents a dopant cation of an element selected from rare earth metals of the IUPAC periodic table of the elements, or from transition metals of the IUPAC periodic table of the elements, or of Ba, Sr, TI, Pb, or Bi, or any combination of such cations, or wherein M″″ is absent; and
a is a value of 0.05-4;
b is a value of 1-10;
c is a value of 1, 2, 3, or 4;
d is a value of above 0-2;
n is a value of 1, 2, 3, or 4.

In one embodiment, a is a value of 0.05-4, or 0.1-4, or 0.2-4, or 0.3-4, or 0.4-3, 0.5-2, or 0.6-1. In one embodiment, a is a value of 0.2-2, or 0.28-1.5, or 0.28-1, or 0.3-1, or 0.32-0.8. In one embodiment, a is a value of 1-4, or 1.3-3, or 1.5-2.

In one embodiment, b is a value of 1-10, or 2-9, or 3-8, or 4-7, or 5-6, or 6.

In one embodiment, c is a value of 1, 2, 3, or 4; or 1, 2, or 3; or 1 or 2.

In one embodiment, d is a value of above 0-2, or 0.05-2, or 0.1-2.

In one embodiment, n is a value of 1, 2, 3, or 4.

In one embodiment, in formula (I), the “dc” is at most 2. I.e. the value of “dc” may not be above 2.

In one embodiment, the charge of
M1′ is 1+;
M2′ is 2+;
M″ is 3+;
M′″ is 4+;
X is 1−;
X′ is 0.5−-3.5−.

In one embodiment, the charge of X′ is 1−-3−. In one embodiment, the charge of X′ is 1−, 2−, or 3−.

The radiation sensing material may be ultraviolet radiation, x-radiation, gamma-radiation, infrared radiation, near-infrared radiation, and/or particle radiation sensing material.

In one embodiment, the particle radiation is alpha radiation, beta radiation, neutron radiation, proton radiation, or any combination thereof.

Ultraviolet light is electromagnetic radiation with a wavelength from 10 nm (30 PHz) to 400 nm (750 THz). The electromagnetic spectrum of ultraviolet radiation (UVR) can be subdivided into a number of ranges recommended by the ISO standard ISO-21348, including ultraviolet A (UVA), ultraviolet B (UVB), ultraviolet C (UVC). The wavelength of UVA is generally considered to be 315-400 nm, the wavelength of UVB is generally considered to be 280-320 and the wavelength of UVC is generally considered to be 100-290 nm. X-radiation is electromagnetic radiation with a wavelength from 0.01 nm to 10 nm. Gamma radiation is electromagnetic radiation with a wavelength from 0.000001 nm to 0.01 nm. Infrared radiation is electromagnetic radiation with a wavelength of 700 nm-2500 nm. The near-infrared radiation is electromagnetic radiation with a wavelength of 750-2500 nm. The radiation sensing material may sense radiation with a wavelength of 1 zm-2500 nm, or 1 zm-2000 nm, or 1 zm-5 μm, or 1 zm-3 μm, or 1 zm-8 μm, or 1 zm-15 μm, or 1 zm-1 mm, or 1 fm-2500 nm, or 1 fm-2000 nm, or 1 fm-5 μm, or 1 fm-3 μm, or 1 fm-8 μm, or 1 fm-15 μm, or 1 fm-1 mm, or 1 μm-2500 nm, or 1 pm-2000 nm, or 1 pm-5 μm, or 1 pm-3 μm, or 1 pm-8 μm, or 1 pm-15 μm, or 1 pm-1 mm, or 0.01 nm-2500 nm, or 1 nm-2000 nm, or 10 nm-5 μm, or 100 nm-3 μm, or 1 μm-8 μm, or 2 μm-15 μm, or 5 μm-1 mm.

In one embodiment, the radiation sensing material is a photochromic material. In one embodiment, the radiation sensing material is a photochromic material changing its color from white to yellow upon exposure to radiation.

The inventors surprisingly found out that it is possible to form a radiation sensing material being able to change color from white to yellow when exposed to radiation. Yellow color may be considered as a result of absorption in the UVA-green region of the electromagnetic spectrum, i.e. from 350-580 nm.

The inventors surprisingly found that the absorption of the F-centre in the radiation sensing material prepared by using a rather high amount of e.g. calcium, is not in the place where one would expected it to be. Ca2+ has a similar size to Na+, which it may at least partly replace in the structure of the radiation sensing material. Thus, one would expect that the absorption band of the F-centre in the radiation sensing material containing a rather high quantity of Ca2+ would be at the same site as the one where only Na+ is present, i.e. in the green region of the electromagnetic spectrum, resulting in the material showing a violet color. However, surprisingly the presence of calcium may result in absorption by the F-centre in the blue region of the spectrum, whereby the material when being exposed to radiation shows a yellow color.

The inventors further surprisingly found out that a second absorption band may be observed in the near-infrared region (NIR), corresponding to a photochromic change in absorption of NIR radiation after the radiation sensing material is exposed to e.g. ultraviolet radiation. In one embodiment, the radiation sensing material is a material changing color from non-absorbing to absorbing near-infrared region of the electromagnetic spectrum upon exposure to radiation, e.g. ultraviolet radiation. In one embodiment, the radiation sensing material is a material absorbing radiation within the near-infrared region of the electromagnetic spectrum.

The near-infrared region (NIR) of the electromagnetic spectrum may be considered to range from 750 nm to 2500 nm. The inventors surprisingly found out that a radiation sensing material may be prepared that absorbs radiation within the near-infrared region of the electromagnetic spectrum. I.e. the radiation sensing material exhibits an absorption band within the near-infrared region.

In one embodiment, the radiation sensing material is a luminescent material, a material showing persistent luminescence, and/or a material showing afterglow.

In one embodiment, the radiation sensing material is a synthetic material. In one embodiment, the radiation sensing material is synthetically prepared.

In this specification, unless otherwise stated, the expression “monoatomic ion” should be understood as an ion consisting of a single atom. If an ion contains more than one atom, even if these atoms are of the same element, it is to be understood as a polyatomic ion. Thus, in this specification, unless otherwise stated, the expression “monoatomic cation” should be understood as a cation consisting of a single atom.

The radiation sensing material represented by formula (I), as a result of being exposed to radiation, has the added utility of changing its color from white to yellow.

In one embodiment, M1′ represents a monovalent monoatomic cation of Li, Na, K, Rb, Cs, or Fr. In one embodiment, M1′ represents a monovalent monoatomic cation of Li, Na, K, Rb, Cs, or Fr, or any combination of such cations. In one embodiment, M1′ represents a monovalent monoatomic cation of an alkali metal selected from a group consisting of Na, Li, K, Rb, Cs, and Fr. In one embodiment, M1′ represents a monovalent monoatomic cation of an alkali metal selected from a group consisting of Na, Li, K, Rb, and Cs. In one embodiment, M1′ represents a monovalent monoatomic cation of an alkali metal selected from a group consisting of Li, K, Rb, Cs, and Fr. In one embodiment, M1′ represents a monovalent monoatomic cation of an alkali metal selected from a group consisting of Li, K, Rb, and Cs. In one embodiment, M1′ represents a monovalent monoatomic cation of Na.

In one embodiment, M1′ represents a monovalent monoatomic cation of Na, or a monovalent monoatomic cation of Li, a monovalent monoatomic cation of K, a monovalent monoatomic cation of Rb, a monovalent monoatomic cation of Cs, or a monovalent monoatomic cation of Fr. In one embodiment, M1′ represents a monovalent monoatomic cation of Na.

In one embodiment, M1′ represents a combination of a monovalent monoatomic cation of Na with a monovalent monoatomic cation of Li, a monovalent monoatomic cation of K, a monovalent monoatomic action of Rb, or a monovalent monoatomic cation of Cs. In one embodiment, M1′ represents a combination of a monovalent monoatomic cation of Na with a monovalent monoatomic cation of K.

In one embodiment, M2′ represents a divalent monoatomic cation of Be, Mg, Ca, Sr, Ba, or Ra. In one embodiment, M2′ represents a divalent monoatomic cation of Be, Mg, Ca, Sr, Ba, or Ra, or any combination of such cations. In one embodiment, M2′ represents a divalent monoatomic cation of an alkaline earth metal selected from a group consisting of Be, Mg, Ca, Sr, Ba, and Ra. In one embodiment, M2′ represents a divalent monoatomic cation of an alkaline earth metal selected from a group consisting of Be, Mg, Ca, Sr, Ba, and Ra, or any combination of such cations.

In one embodiment, M2′ represents a divalent monoatomic cation of Be, or a divalent monoatomic cation of Mg, or a divalent monoatomic cation of Ca, or a divalent monoatomic cation of Sr, or a divalent monoatomic cation of Ba, or a divalent monoatomic cation of Ra. In one embodiment, M2′ represents a divalent monoatomic cation of Ca.

In one embodiment, M1′ represents a monovalent monoatomic cation of Na and M2′ represents a divalent monoatomic cation of Ca. In one embodiment, M1′ represents a combination of a monovalent monoatomic cation of Na and a monovalent monoatomic cation of K, and M2′ represents a divalent monoatomic cation of Ca.

In one embodiment, the radiation sensing material comprises 16-31 mol-%, or 24-29 mol-% of M1′.

In one embodiment, the radiation sensing material comprises 0.7-14 mol-%, or 2-7 mol-% of M2′.

In one embodiment, (M1′8−2aM2′a) comprises 0-99.4 weight-%, or 1-98 mol-%, or 5-97 mol-%, or 10-96 mol-%, or 20-95 mol-%, or 30-90 mol-%, or 40-85 mol-%, or 50-80 mol-%, or 60-70 mol-%, of the monoatomic cation of Na. In one embodiment, (M1′8−2aM2′a) comprises 75-99 mol-%, or 78-98 mol-%, or 80-97.5 mol-%, or 83-97 mol-%, or 85-96 mol-%, or 87-94 mol-%, of the monoatomic cation of Na.

In one embodiment, M″ represents a trivalent monoatomic cation of a metal selected from a group consisting of Al and Ga, or a trivalent monoatomic cation of B, or any combination of such cations. In one embodiment, M″ represents a trivalent monoatomic cation of a metal selected from a group consisting of Al and Ga, or a combination of such cations. In one embodiment, M″ represents a trivalent monoatomic cation of B.

In one embodiment, M′″ represents a monoatomic cation of an element selected from a group consisting of Si and Ge, or a combination of such cations.

In one embodiment, X represents an anion of an element selected from a group consisting of F, Cl, Br, I, and At, or any combination of such anions. In one embodiment, X represents an anion of an element selected from a group consisting of F, Cl, Br, and I, or any combination of such anions. In one embodiment, X is absent.

In one embodiment, X′ represents an anion of an element selected from a group consisting of O, S, Se, and Te, or any combination of such anions. In one embodiment, X′ represents an anion of one or more elements selected from a group consisting of O, S, Se, and Te, or any combination of such anions. In one embodiment, X′ represents a monoatomic or a polyatomic anion of one or more elements selected from a group consisting of O, S, Se, and Te, or any combination of such anions. In one embodiment, X′ represents an anion of S. In one embodiment, X′ is (SO4)2−. In one embodiment X′ is absent.

In one embodiment, either X or X′ is present, or both X and X′ are present. In one embodiment, at least X′ is present.

In one embodiment, the radiation sensing material is doped with at least one transition metal ion. In one embodiment, the radiation sensing material is represented by formula (I), wherein M″″ represents a cation of an element selected from transition metals of the IUPAC periodic table of the elements, or of Ba, Sr, TI, Pb, or Bi, or any combination of such cations. In one embodiment, M″″ represents a cation of an element selected from a group consisting of Yb, Er, Tb, and Eu, or of an element selected from a group consisting of Ti, V, Cr, Mn, Fe, Co, Ni, Cu, Ag, W, and Zn, or any combination of such cations. In one embodiment, M″″ represents a cation of an element selected from transition metals of the f-block of the IUPAC periodic table of the elements. In one embodiment, M″″ represents a cation of an element selected from transition metals of the d-block of the IUPAC periodic table of the elements. In one embodiment, M″″ represents a cation of an element selected from a group consisting of Ti, V, Cr, Mn, Fe, Co, Ni, Cu, Ag, W, and Zn, or any combination of such cations. In one embodiment, M″″ represents a cation of Ti. In one embodiment, M″ represents a dopant cation of an element selected from rare earth metals of the IUPAC periodic table of the elements. In one embodiment, M″ represents a cation of an element selected from a group consisting of Yb, Er, Tb, and Eu, or any combination of such cations. In one embodiment, M″ represents a combination of two or more dopant cations.

In one embodiment, the radiation sensing material is represented by formula (I), wherein M″″ is absent. In this embodiment, the radiation sensing material is not doped.

In one embodiment, the radiation sensing material represented by the formula (I) comprises M″″ in an amount of 0.001-10 mol-%, or 0.001-5 mol-%, or 0.1-5 mol-% based on the total amount of the radiation sensing material.

The radiation sensing material may be synthesized by a reaction following the teaching given in Norrbo et al. (Norrbo, I.; Głuchowski, P.; Paturi, P.; Sinkkonen, J.; Lastusaari, M., Persistent Luminescence of Tenebrescent Na8Al6Si6O24(Cl,S)2: Multifunctional Optical Markers. Inorg. Chem. 2015, 54, 7717-7724), which reference is based on Armstrong & Weller (Armstrong, J. A.; Weller, J. A. Structural Observation of Photochromism. Chem. Commun. 2006, 1094-1096) but with varying the amounts of starting materials used. As an example, 3 Å or 4 Å molecular sieves or Zeolite A; sulfate(s) such as Na2SO4 and/or Na2SeO3; salt(s) such as CaCl2,LiCl, NaCl, KCl, CsCl, and/or RbCl can be used as the starting materials. Other examples of salts that may be used are: NaBr, NaI, CaBr2, CaI2, LiBr, LiI, KBr, KI, RbBr, RbI, CsBr and CsI. As an example only, the starting materials may comprise 52.1 mol-% of 3 Å or 4 Å molecular sieves, 0.0-41.2 mol-% of NaCl, 2.2-43.4 mol-% of CaCl2·6H2O and 4.5 mol-% of Na2SO4. The at least one dopant may be added as an oxide, such as TiO2, a chloride, a sulfide, a bromide, a phosphate, or a nitrate. The material can be prepared as follows: 3 Å or 4 Å molecular sieves or Zeolite A may first be dried at 500° C. for 1 h. The initial mixture may then be heated at 850° C. in air for e.g. 2 h, 5 h, 12 h, 24 h, 36 h, 48 h, or 72 h. The product may then be freely cooled down to room temperature and ground. Finally, the product may be re-heated at 850° C. for 2 h under a flowing 12% H2+88% N2 atmosphere. If needed, the as-prepared materials may be washed with water to remove any excess impurities. The purity can be verified with an X-ray powder diffraction measurement.

A molecular sieve is a material with pores, or small holes, of uniform size. These pore diameters are similar in size to small molecules, and thus large molecules cannot enter or be adsorbed, while smaller molecules can. The diameter of a molecular sieve is measured in Ångström (Å) or nanometers (nm). 3 Å molecular sieves may be considered to have the approximate chemical formula of ((K2O)⅔(Na2O)⅓)·Al2O3·2SiO2·9/2H2O. The 4 Å molecular sieves may be considered to have the chemical formula of Na2O·Al2O3·2SiO2·9/2H2O.

The present disclosure further relates to a device comprising the radiation sensing material as defined in the current specification. The device may be a sensor, a detector, or an indicator.

The sensor may be an active sensor or a passive sensor. An active sensor is a sensing device that requires an external source of power to operate. Active sensors contrast with passive sensors, which detect and respond to some type of input from the physical environment. The passive sensor does not require an external source of power to operate.

The detector may be an image detector. The image detector may be used e.g. as a detector in radiation-based imaging technique.

The detector may be used in imaging carried out in the industry, in non-destructive testing, and/or to imaging welding. The detector may further be used in e.g. point-of-care analysis or point-of-care testing. Point-of-care testing (POCT), also called bedside testing, may be defined as medical diagnostic testing at or near the point of care, i.e. at the time and place of patient care. This is contrary to the situation wherein testing is wholly or mostly confined to a medical laboratory, which entails sending off a specimen away from the point of care and then waiting e.g. hours or days to learn the results.

The indicator can be applied e.g. in a label on a bottle of skin cream or sunscreen, wherein the change in color would alert the user to the application of the sun protection. The material may be used e.g. on the outside of a window to alert the residents before going out about the ultraviolet radiation intensity. The radiation sensing material can also be mixed as a powder in the raw materials used for the production of a plastic bottle, a sticker, a glass and a similar product that is to be provided with e.g. a UV indicator. The radiation sensing material may also be used in a clothing, e.g. in a swim wear, the color change of which may indicate of too much ultraviolet radiation to alert the user to seek shade. The products containing the radiation sensing material may also be conceived as jewelry. The radiation sensing material can be used as a display portion of a meter, which is calibrated according to the shade.

The sensor, detector, or indicator may be reusable. The radiation sensing material has the added utility that its color can be returned to colorless (white), i.e. decolored, with visible light or heating thus enabling it to be reused. I.e. as a result of the radiation sensing material being reusable, one is able to reuse the same sensor, detector, or indicator one or several times.

The present disclosure further relates to the use of the radiation sensing material as defined in the current specification as a light source, in a consumer product, in a security device, in detecting, in imaging, in image acquisition, in display, screen, window, or touch screen solution, in medicine, in drug development, and/or in diagnostics.

Further is disclosed the use of the radiation sensing material as disclosed in the current specification for detection of a disease, in an antibody or staining entity, in a biomarker test kit, in a screening platform, and/or in a combination with a further material.

The light source may be selected from a group consisting of a display e.g. for presenting alphanumerical and graphical information, a screen, a backlight unit, a front light unit, a lighting element, a decorative element, a space application, and a fluorescent lamp. Ultraviolet radiation, x-radiation, or gamma radiation in space may be used as light source to generate blue and red luminescence or their combination e.g. to implement color and light to a display, a heads-up display (HUD), a screen, or a window.

The security device may be selected from a group consisting of an ink, a thread, a paper, a foil a hologram, and a powder. The powder may be mixed with e.g. paint, polymer, liquids etc. In one embodiment, the security device is used on a banknote, a passport document or an identity card.

The security device may be used in a commercial product. The security device may be used in a work of art or in a historical artifact.

The radiation sensing material may be used in diagnosing a sample received from human or animal body or in diagnosing the human or animal body directly. The sample may be selected from a group consisting of a body fluid, a tooth, a bone, and a tissue. The sample may comprise blood, skin, tissue and/or cells. The radiation sensing material may be used in in vivo imaging or in in vivo diagnostics. The imaging may be medical imaging.

The radiation sensing material may further be used in imaging such as stimulated emission depletion (STED) imaging, fluorescence resonance energy transfer (FRET) imaging, or dynamic imaging.

The present disclosure further relates to the use of the radiation sensing material as defined in the current specification for indicating the presence and/or intensity of ultraviolet radiation, x-radiation, gamma-radiation, infrared radiation, near-infrared radiation, and/or particle radiation.

The radiation sensing material as described in current specification has the ability to retain radiation energy, i.e. the radiation sensing material is able to trap therein the radiation that it is exposed to. The retained radiation may be released from the radiation sensing material later at a predetermined point of time. The radiation sensing material may emit visible light as a result of changing, e.g. increasing or decreasing, the temperature thereof and/or as a result of optical stimulation.

The radiation sensing material may be configured to retain radiation exposed thereon for a predetermined period of time. The radiation sensing material may be configured to release the retained radiation as visible light when being subjected to heat treatment and/or optical stimulation. The irradiated radiation may be retained in the radiation sensing material for a predetermined period of time. The predetermined period of time may be at least 1 minute, or at least 2 minutes, or at least 5 minutes, or at least 10 minutes, or at least 15 minutes, or at least 0.5 hour, or at least 1 hour, or at least 2 hours, or at least 5 hours, or at least 6 hours, or at least 8 hours, or at least 12 hours, or at least 18 hours, or at least 24 hours, or at least one week, or at least one month. The predetermined period of time may be at most 3 months, or at most one month, or at most one week, or at most 24 hours. The predetermined period of time may be 1 minute-3 months, or 10 minutes-one month, or 0.5 h-one week. In one embodiment, said predetermined period of time is 0.5 h-3 months.

Then the radiation sensing material may be subjected to e.g. heating and/or optical stimulation to release the retained radiation from the radiation sensing material. Optical stimulation of the radiation sensing material may comprise subjecting the radiation sensing material to electromagnetic radiation having a wavelength of 310-1400 nm. In one embodiment, the optical stimulation of the radiation sensing material comprises subjecting the radiation sensing material to visible light, ultraviolet radiation and/or to near infrared radiation. The optical stimulation of the radiation sensing material may be carried out by using a laser, a light emitting diode (LED), a microLED, an organic light-emitting diode (OLED), an active-matrix organic light emitting diode (AMOLED), an incandescent lamp, a halogen lamp, any other optical stimulation luminescence light source, or any combination thereof.

The radiation sensing material may be used in a thermoluminescent dosimeter or in an optically stimulated luminescent dosimeter. The device comprising the radiation sensing material may thus be a thermoluminescent dosimeter or an optically stimulated luminescent dosimeter.

The amount of visible light emitted by the sensor material may be determined by optical imaging, by photography, by thermally stimulated luminescence, and/or by optically stimulated luminescence. The amount of visible light emitted by the sensor material may be visually determined.

The radiation sensing material, as a result of being subjected to radiation has the added utility of showing color intensity, which is proportional with the dose of the radiation that is has been exposed to.

The radiation sensing material may be used to determine the intensity of radiation present. E.g. the radiation sensing material may be used to indicate the intensity of ultraviolet radiation emitted by the sun. The intensity of the radiation may be determined e.g. by a method comprising:
a) providing a radiation sensing material as disclosed in the current specification;
b) subjecting the radiation sensing material provided in step a) to radiation;
c) determining a change in the color of the material as result of being subjected to radiation; and
d) comparing the color of the material with a reference indicating the correlation of the intensity of the radiation with the color of the radiation sensing material.

Step c) may be carried out by visually determining the change in the color of the material. The reference may be e.g. a card or the like that indicates the correlation between the intensity of the radiation and the intensity of the color of the radiation sensing material. The intensity of the color of the radiation sensing material may be used to indicate the value of e.g. the UV index.

Thus, the present disclosure further relates to the use of the radiation sensing material represented by the formula (I) as disclosed in the current specification for indicating the amount or intensity of radiation present in the environment. The radiation sensing material has the added utility of being able to change color under the exposure to radiation. The intensity of the color is dependent on the amount of radiation, such as ultraviolet radiation, that reaches the radiation sensing material. The color change of the radiation sensing material may be based on photochromism. Radiation may induce color centers in the radiation sensing material. The more radiation that hit the material the more color centers are formed and thus a deeper color is obtained. In one embodiment, the radiation sensing material is a photochromic material.

When in use the radiation sensing material may be exposed to radiation for a predetermined period of time, such as for 0.01 seconds-24 hours, or 0.05 seconds-1 hour, or 0.1 seconds-20 minutes, or 1 second-10 minutes, or 5 seconds-5 minutes, or 30 seconds-1 minute. The time the radiation sensing material is allowed to be exposed to the radiation may depend on the application where the radiation sensing material is used and thus on the amount of radiation to which the radiation sensing material is to be exposed to.

The present disclosure further relates to a material derived from the radiation sensing material as disclosed in the current specification. I.e. the radiation sensing material as disclosed in the current specification may be used to derive or produce a further material.

The radiation sensing material has the added utility of enabling to detect the presence of radiation, such as ultraviolet radiation, x-radiation, gamma radiation, infrared radiation, near-infrared radiation, and/or particle radiation. Further, the radiation sensing material has the added utility of indicating the intensity of the radiation irradiated thereon.

The radiation sensing material has the added utility of being a low-cost material to be used in different device in different applications.

### EXAMPLES

Reference will now be made in detail to various embodiments, examples of which are illustrated in the accompanying drawings.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

### Example 1—Preparing Materials

In this example a radiation sensing material represented by the formula Na8−x−yKxCay(AlSi)6O24(Cl,S)2 (wherein x=0-6, y may vary and be=0.28-1 and was in this example 0.36) was prepared in the following manner: 0.7 g of dry 3 Å molecular Sieves (Purmol® 3ST from Zeochem), 0.06 g of dry Na2SO4, 0.197 g of dry NaCl and 0.162 g of CaCl2·6H2O were measured, mixed and ground. The mixture was placed in an aluminium oxide boat and heated at 850° C. in air for 5 hours. Then the mixture was re-ground and placed back into an aluminium oxide boat for reduction. The reduction was carried out at 850° C. for 2 h under a flowing of H2/N2 atmosphere. The product was then again ground.

In a similar manner a radiation sensing material represented by the formula Na8−2yCay(AlSi)6O24(Cl,S)2 (wherein y=0.28-1) was prepared with the difference that 4 Å molecular sieves (Purmol® 4ST from Zeochem) were used instead of 3 Å molecular sieves.

In a similar manner a radiation sensing material represented by the formula Na8−2yCay(AlSi)6O24(Cl,S)2 (wherein y=0.28-1) was prepared with the difference that Zeolite A (Sigma-Aldrich, CAS #1318-02-1) was used instead of 3 Å molecular sieves.

### Example 2—Preparing Different Materials

Following the general description presented in example 1, the following materials were prepared by using the following starting materials:

| Material to be prepared | Starting materials |
|---|---|
| Na_{8-x-2y}KₓCa_{y}(AlSi)₆O₂₄(Cl, S)₂, | 3 Å molecular sieves, NaCl, |
| wherein | CaCl₂•6 H₂O, Na₂SO₄ |
| 0 ≤ x ≤ 6, | |
| y = 0.1, 0.2, 0.28, 0.3, 0.31, 0.32, | |
| 0.34, 0.36, 0.38, 0.40, 0.5, 0.54, | |
| 0.6, 0.64, 0.7, 0.72, 0.74, 0.76, | |
| 0.78, 0.8, 1, 1.5, or 2 | |
| Na_{8-2y}Ca_{y}(AlSi)₆O₂₄(Cl, S)₂, | 4 Å molecular sieves, NaCl, |
| wherein | CaCl₂•6 H₂O, Na₂SO₄ |
| y = 0.1, 0.2, 0.3, 0.40, 0.5, 1, | |
| 1.5, or 2 | |
| Na₇Ca_{0.5}(AlSi)₆O₂₄(Cl, S)₂ | Zeolite A, NaCl, CaCl₂•6 H₂O, |
| | Na₂SO₄ |
| Na₇Ca_{0.5}(AlSi)₆O₂₄(Cl, S, Se)₂, | 4 Å molecular sieves, NaCl, |
| n(S):n(Se) = 1:1 | CaCl₂•6 H₂O, Na₂SO₄, Na₂SeO₃ |
| Na₇Ca_{0.5}(AlSi)₆O₂₄(Cl, Se)₂ | 4 Å molecular sieves, NaCl, |
| | CaCl₂•6 H₂O, Na₂SeO₃ |
| Na_{7.28}Ca_{0.36}(AlSi)₆O₂₄(Cl, S)₂ | Zeolite A, NaCl, CaCl₂•6 H₂O, |
| | Na₂SO₄ |
| Na_{7.28}Ca_{0.36}(AlSi)₆O₂₄(Cl, S, Se)₂, | Zeolite A, NaCl, CaCl₂•6 H₂O, |
| n(S):n(Se) = 1:1 | Na₂SO₄, Na₂SeO₃ |
| Na_{7.28}Ca_{0.36}(AlSi)₆O₂₄(Cl, Se)₂ | Zeolite A, NaCl, CaCl₂•6 H₂O, |
| | Na₂SeO₃ |
| Na_{7.32}Ca_{0.34}(AlSi)₆O₂₄(Br, S)₂, | 4 Å molecular sieves, NaBr, |
| | CaBr₂, Na₂SO₄ |
| Na_{7.32}Ca_{0.34}(AlSi)₆O₂₄(I, S)₂, | 4 Å molecular sieves, Nal, |
| | Cal₂, Na₂SO₄ |
| Na₇₋ₓKₓCa_{0.5}(AlSi)₆O₂₄(Br, S)₂, | 3 Å molecular sieves, NaBr, |
| | CaBr₂, Na₂SO₄ |
| Na_{6.8-x}KₓCa_{0.6}(AlSi)₆O₂₄(Br, S)₂, | 3Å molecular sieves, NaBr, |
| | CaBr₂, Na₂SO₄ |
| Na_{6.8-x}KₓCa_{0.6}(AlSi)₆O₂₄(Br, S)₂, | 3 Å molecular sieves, Nal, |
| | Cal₂, Na₂SO₄ |
| Na₇₋ₓKₓCa_{0.5}(AlSi)₆O₂₄(Cl, Br, S)₂, | 3 Å molecular sieves, NaCl, |
| wherein | CaBr₂, Na₂SO₄ |
| 0 ≤ x ≤ 6 | |
| (n(Cl):n(Br) nominally 3:2) | |
| Na₇₋ₓKₓCa_{0.5}(AlSi)₆O₂₄(Cl, I, S)₂, | 3 Å molecular sieves, NaCl, |
| wherein | Cal₂, Na₂SO₄ |
| 0 ≤ x ≤ 6 | |
| (n(Cl):n(I) nominally 3:2) | |

### Example 3—Preparing Different Materials

In this example the radiation sensing material represented by formula Na7.32Ca0.34(AlSi)6O24(Cl,S)2 was prepared in the following manner: 0.4 g of dry NaAlO2, 0.3 g of SiO2, 0.06 g of dry Na2SO4, 0.199 g of dry NaCl and 0.153 g of CaCl2·6H2O were ground together and placed in an autoclave with approximately 20 ml of distilled water. The autoclave was placed in an oven at 180° C. for 48 h. The autoclave was allowed to cool to room temperature, after which the sample was removed from the autoclave and dried at 100° C. for 15 minutes. The dry powder was ground and placed into an alumina boat for reduction. The reduction was carried out at 850° C. for 2 h under a flowing 12% H2/88% N2 atmosphere. Once cool, the product was collected.

### Example 4—Preparing Different Materials

Following the general description presented in example 3, the following materials were prepared by using the following starting materials:

| Material to be prepared | Starting materials |
|---|---|
| Na_{7.32}Ca_{0.34}(AlSi)₆O₂₄(Cl, S)₂ | NaAlO₂, SiO₂, NaCl, CaCl₂•6H₂O, |
| | Na₂SO₄ |

### Example 5—Testing of a Sample of the Prepared Material

Samples of prepared materials were tested by:

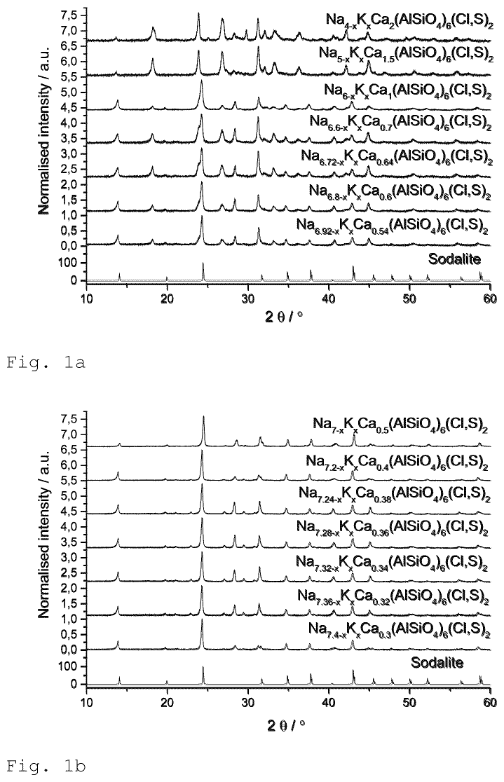

X-ray powder diffraction (XRD) measured with a Huber G670 detector and copper Kα1 radiation (λ=1.54060 Å). See FIG. 1a and FIG. 1b. XRD patterns show that increasing the amount of calcium, makes the structure less sodalite-type.

The elemental composition of the prepared material was determined with X-ray fluorescence (XRF) measurement using a PANalytical Epsilon 1 device with internal Omnian calibration and Na 1 h measurement program.

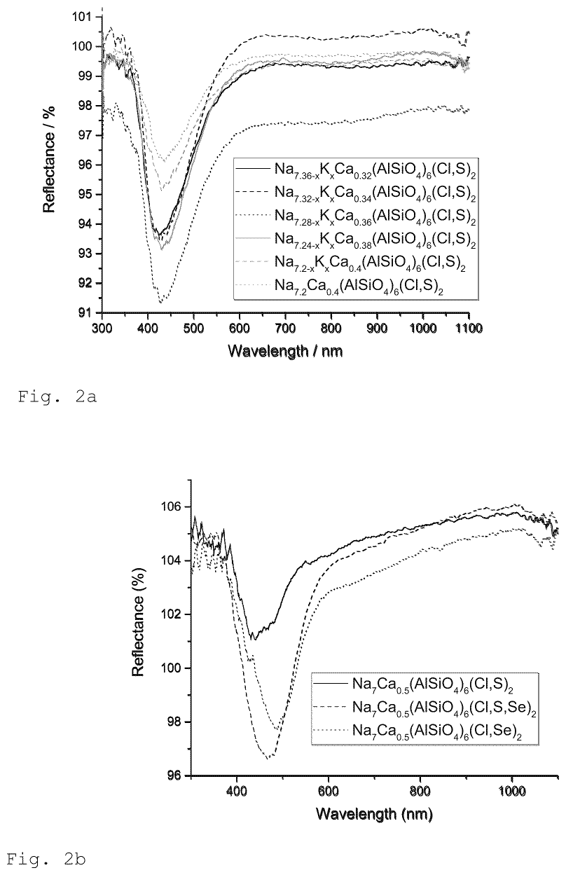

The photochromism of the material was investigated with reflectance measurements using Avantes SensLine AvaSpec-HS-TEC spectrometer connected to an optical fibre. The reference spectrum of the material was measured before irradiation. The material was irradiated under a 254 nm UV-lamp for 5 minutes and the final reflectance spectrum was measured after irradiation. See FIG. 2a, FIG. 2b, and FIG. 2c. The F-center at 426 nm causes the yellow color change.

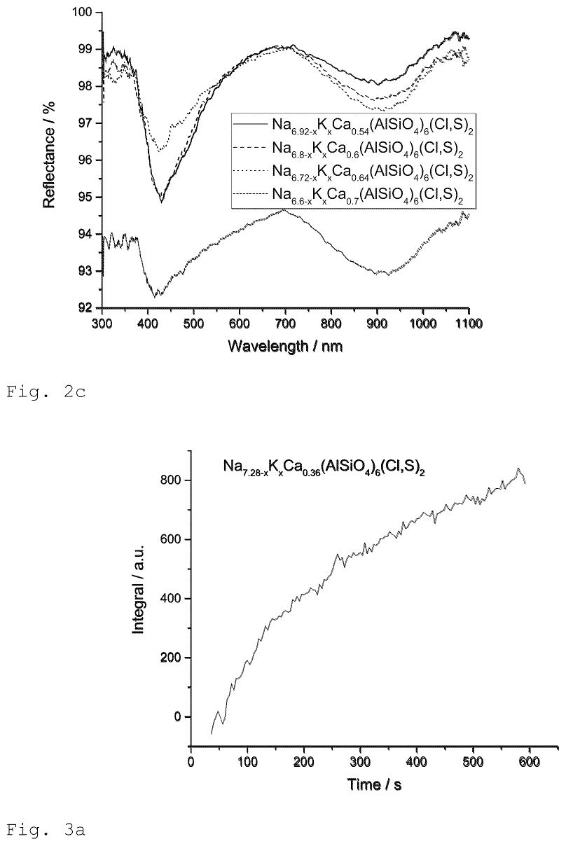

Tenebrescence color rise curve was measured using Avantes SensLine AvaSpec-HS-TEC spectrometer connected to an optical fibre and LOT-QuantumDesign monochromator. The sample was irradiated with 254 nm UV-lamp and reflectance values were measured every 4 seconds for 10 minutes. The same setup was used to measure tenebrescence excitation spectrum. Reflectance was measured from 200 nm to 300 nm between every 20 nm and from 300 nm to 450 nm between every 25 nm. See FIG. 3a, FIG. 3b, and FIG. 3c. The graphs show that the color change is dependent on the dose of ultraviolet radiation.

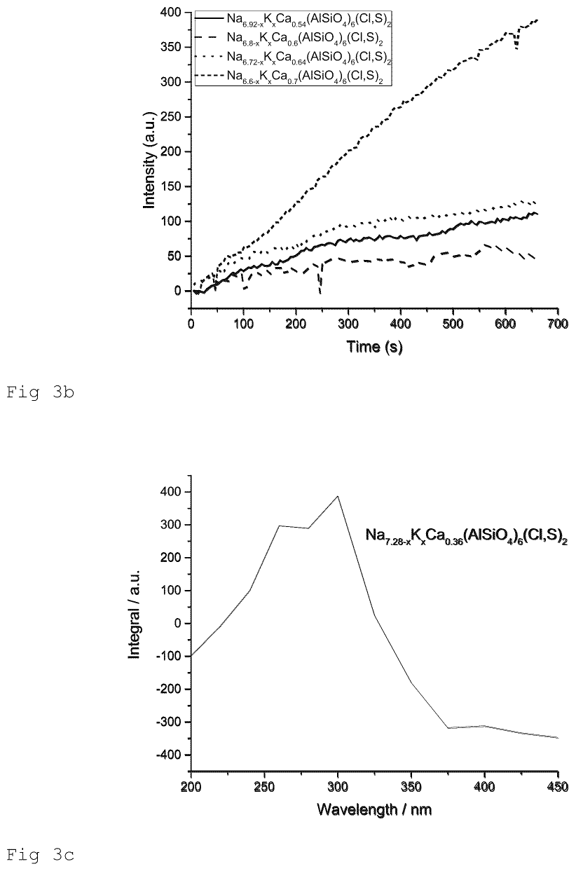

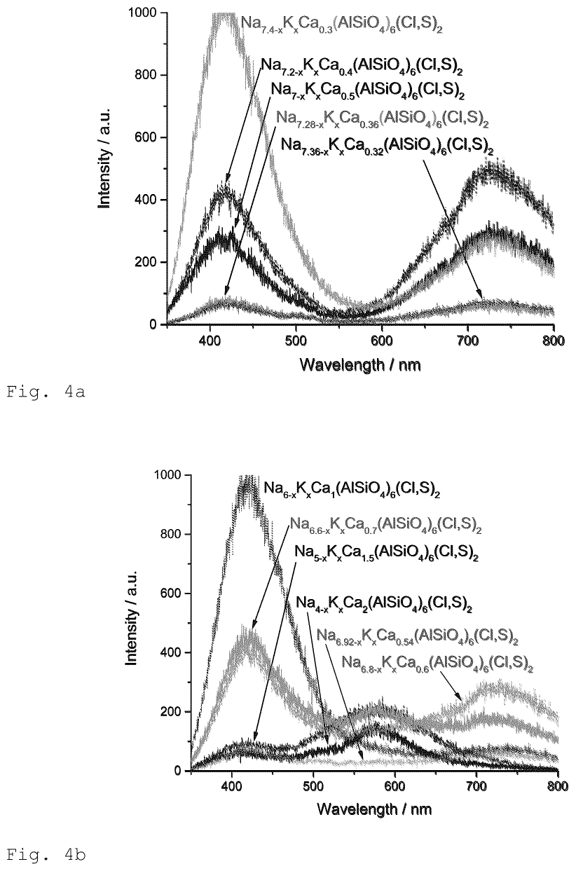

The luminescence properties (see FIG. 4a and FIG. 4b.) and persistent luminescence (see FIG. 5a and FIG. 5b) properties of the sample were measured with a Varian Cary Eclipse Fluorescence Spectrophotometer containing a Hamamatsu R928 photomultiplier and a 150 W xenon lamp. For persistent luminescence spectrum, the material was excited with a 254 nm UV-lamp for 5 minutes and the spectrum was measured with a 30 s delay after irradiation.

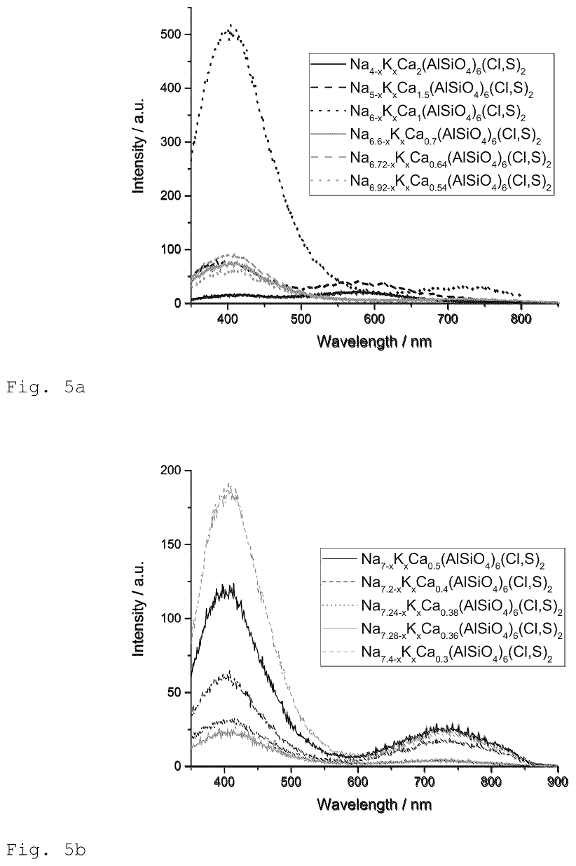

The optical energy storage property of the material was investigated with thermoluminescence measurements using MikroLab Thermoluminescent Materials Laboratory Reader RA′04. See FIG. 6.

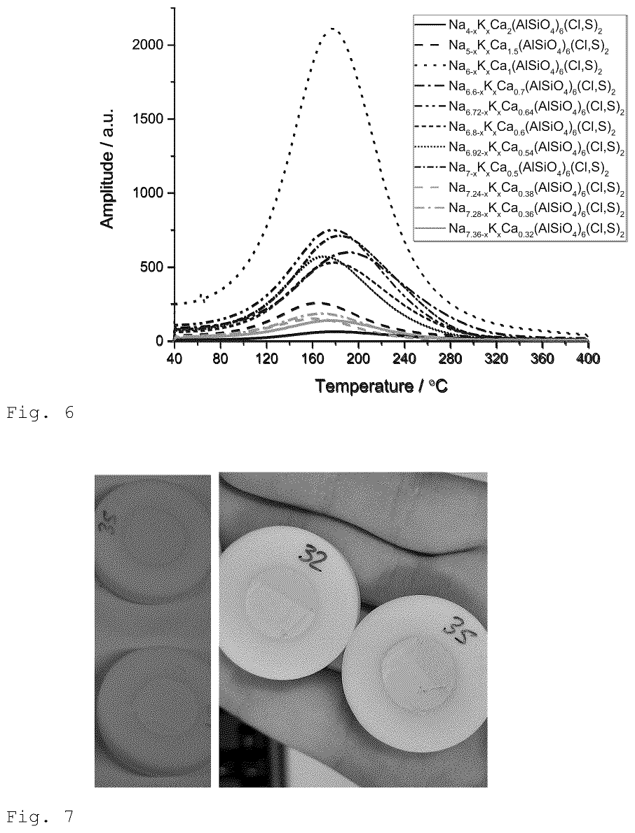

In FIG. 7 a photograph of the yellow photochromism of the material is shown. On the left is shown the one and the same sample of Na7.28Ca0.36(AlSiO4)6(Cl,S)2, after coloration (top) and before coloration (bottom). On the right is shown two additional samples after coloration. Number 32 represents a sample of Na6.72−xKxCa0.64(AlSiO4)6(Cl,S)2 and number 35 represents a sample of Na6.6−xKxCa0.7(AlSiO4)6(Cl,S)2

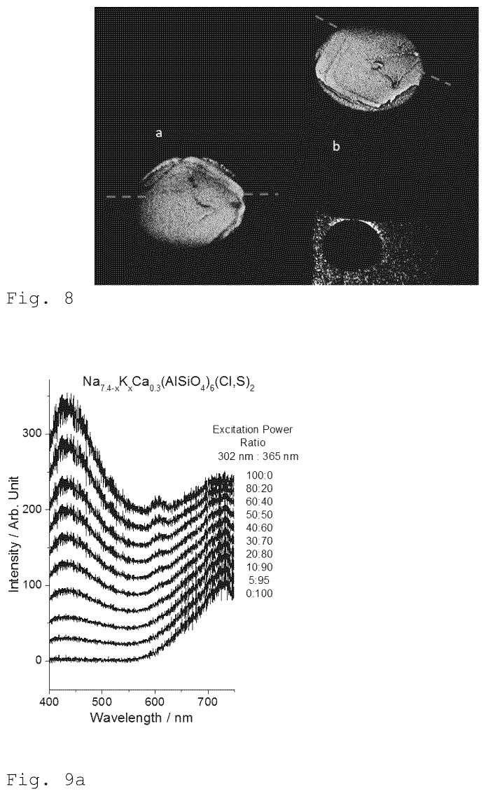

In FIG. 8 a photograph of the near-infrared photochromism of the material is shown. The areas above the dashed lines in each picture were colored by approximately 15 minutes exposure to 254 nm UV. Areas below the lines were uncolored. The photos were taken under 900 nm light using 8 s exposure time on the camera. The contrast of the images was enhanced to show the difference between colored and uncolored areas. Sample a was Na6.72−xKxCa0.64(AlSiO4)6(Cl,S)2 and sample b was Na6.6−xKxCa0.7(AlSiO4)6(Cl,S)2.

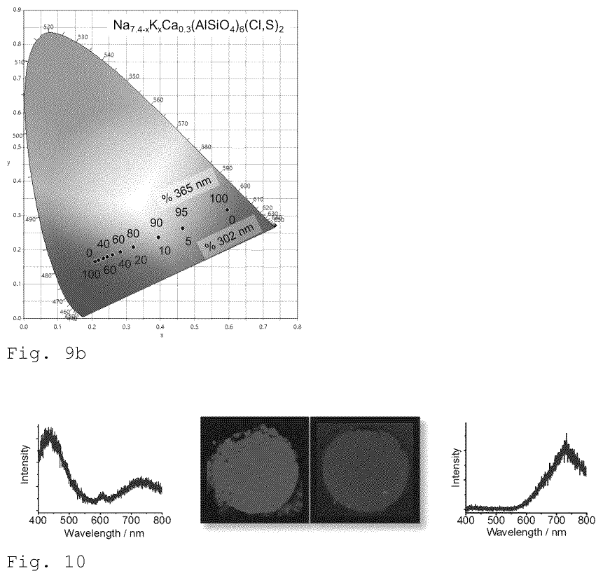

In FIGS. 9a and 9b, as well as FIG. 10 are shown the results from the following double-excitation emission simulations: A sample of Na7.4−xKxCa0.3(AlSiO4)6(Cl,S)2 (prepared using 3 Å molecular sieves) was excited with 302 nm UV lamp and its luminescence spectrum was recorded. The same material was excited with 365 nm UV lamp and its luminescence spectrum was recorded. To simulate a double-excitation setup of 302 and 365 nm UV lamps, average spectra weighted with the percentage of each UV lamp used were calculated. The calculated spectra were plotted and CIE x,y color coordinates were calculated for the series using Osram Color Calculator software. The results show that with double-excitation the color of luminescence can be controlled to blue and red as well as all the shades and combinations between them.

It is obvious to a person skilled in the art that with the advancement of technology, the basic idea may be implemented in various ways. The embodiments are thus not limited to the examples described above; instead, they may vary within the scope of the claims.

The embodiments described hereinbefore may be used in any combination with each other. Several of the embodiments may be combined together to form a further embodiment. A radiation sensing material, a device or a use, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A radiation sensing material represented by the following formula (I):
(M1′₈₋₂ₐM2′ₐ)(M″_{14-(4b/3)}M′″_{b})O₂₄(X_{2-dc}dX′ₙ^{c-}):M″″ formula (I)
wherein
M1′ represents a monovalent monoatomic cation of an alkali metal selected from Group 1 of the IUPAC periodic table of the elements, or any combination of such cations;
M2′ represents a divalent monoatomic cation of an alkaline earth metal selected from Group 2 of the IUPAC periodic table of the elements, or any combination of such cations;
M″ represents a trivalent monoatomic cation of an element selected from Group 13 of the IUPAC periodic table of the elements, or any combination of such cations;
M′″ represents a monoatomic cation of an element selected from Group 14 of the IUPAC periodic table of the elements, or any combination of such cations;
X represents an anion of an element selected from the halogens of Group 17 of the IUPAC periodic table of the elements, or any combination of such anions;
X′ represents an anion of one or more elements selected from the chalcogens of Group 16 of the IUPAC periodic table of the elements, or any combination of such anions;
M″″ represents a dopant cation of an element selected from rare earth metals of the IUPAC periodic table of the elements, or from transition metals of the IUPAC periodic table of the elements, or of Ba, Sr, TI, Pb, or Bi, or any combination of such cations, or wherein M″″ is absent; and
a is a value of 0.05-4
b is a value of 1-10
c is a value of 1, 2, 3, or 4
d is a value of above 0-2
n is a value of 1, 2, 3, or 4.

2. The radiation sensing material of claim 1, wherein the charge of
M1′ is 1+;
M2′ is 2+;
M″ is 3+;
M″ is 4+;
X is 1−; and
X′ is 0.5−-3.5−.

3. The radiation sensing material of claim 1, wherein M1′ represents a monovalent monoatomic cation of Li, Na, K, Rb, Cs, or Fr.

4. The radiation sensing material of claim 1, wherein M2′ represents a divalent monoatomic cation of Be, Mg, Ca, Sr, Ba, or Ra.

5. The radiation sensing material of claim 1, wherein M1′ represents a monovalent monoatomic cation of Na and M2′ represents a divalent monoatomic cation of Ca.

6. The radiation sensing material of claim 1, wherein M″ represents a trivalent monoatomic cation of a metal selected from a group consisting of Al and Ga, or a trivalent monoatomic cation of B, or any combination of such cations.

7. The radiation sensing material of claim 1, wherein M″ represents a monoatomic cation of an element selected from a group consisting of Si and Ge, or a combination of such cations.

8. The radiation sensing material of claim 1, wherein X represents an anion of an element selected from a group consisting of F, Cl, Br, I, and At, or any combination of such anions.

9. The radiation sensing material of claim 1, wherein X′ represents a monoatomic or a polyatomic anion of one or more elements selected from a group consisting of O, S, Se, and Te, or any combination of such anions.

10. The radiation sensing material of claim 1, wherein M″″ represents a cation of an element selected from a group consisting of Yb, Er, Tb, and Eu, or of an element selected from a group consisting of Ti, V, Cr, Mn, Fe, Co, Ni, Cu, Ag, W, and Zn, or any combination of such cations.

11. The radiation sensing material of claim 1, wherein the radiation sensing material is ultraviolet radiation, x-radiation, gamma-radiation, infrared radiation, near-infrared radiation, and/or particle radiation, sensing material.

12. The radiation sensing material of claim 1, wherein the radiation sensing material is a photochromic material changing its color from white to yellow upon exposure to radiation.

13. The radiation sensing material of claim 1, wherein the radiation sensing material is a material absorbing radiation within the near-infrared region of the electromagnetic spectrum.

14. The radiation sensing material of claim 1, wherein the radiation sensing material is a luminescent material, a material showing persistent luminescence, and/or a material showing afterglow.

15. A device, wherein the device comprises the radiation sensing material as defined in claim 1.

16. A material derived from the radiation sensing material as defined in claim 1.

17. The use of the radiation sensing material as defined in claim 1 for indicating the presence and/or intensity of ultraviolet radiation, x-radiation, gamma-radiation, infrared radiation, near-infrared radiation, and/or particle radiation.

18. The use of the radiation sensing material as defined in claim 1 as a light source, in a consumer product, in a security device, in detecting, in imaging, in image acquisition, in display, screen, window or touch screen solutions, in medicine, in drug development, and/or in diagnostics.

19. The use of the radiation sensing material as defined in claim 1 for detection of a disease, in an antibody or staining entity, in a biomarker test kit, in a screening platform, and/or in a combination with a further material.
